(19) United States
(12) Patent Application Publication
(10) Pub. No.: US 2026/0299975 A1
(43) Pub. Date: Oct. 1, 2026

(54) METHOD AND A SYSTEM FOR FAST, EXPLAINABLE AND DOMAIN-AWARE AUTOMATED FEATURE ENGINEERING

(71) Applicant: QNB FINANSBANK A.S., Istanbul (TR)

(72) Inventors: Erdem UNAL, Istanbul (TR); Atilla KARAAHMETOGLU, Istanbul (TR); Baris AKGUN, Istanbul (TR); llhan CAGATAY, Istanbul (TR); Murat KORAS, Istanbul (TR); Ugur AYDIN, Istanbul (TR); Melih GUVEN, Istanbul (TR)

(73) Assignee: QNB FINANSBANK A.S., Istanbul (TR)

(21) Appl. No.: 19/480,372

(22) PCT Filed: Dec. 19, 2023
(86) PCT No.: PCT/TR2023/051589

§ 371 Date: Oct. 31, 2025

(51) Int. Cl. G06F 9/451

(52) U.S. Cl. CPC G06F 9/451

(57) ABSTRACT

An automated process for feature engineering is designed based on constructor type feature generation, integrating domain knowledge via creation and elimination rules, and the automated process operates within the realm of artificial intelligence, particularly in machine learning, aiming to enhance ease of use, improve prediction performance, and reduce resource utilization encompassing processor, memory, storage, among others, while concurrently reducing computation time.

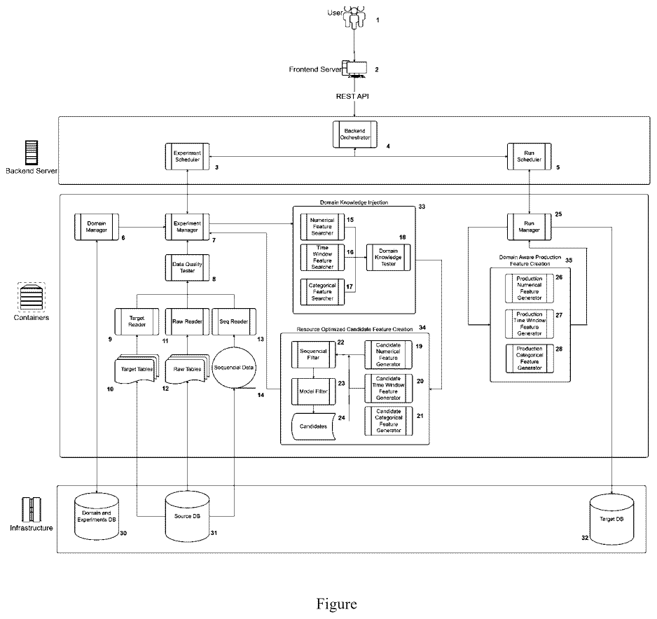

### CROSS REFERENCE TO THE RELATED APPLICATIONS

This application is the national phase entry of International Application No. PCT/TR 2023/051589, filed on Dec. 19, 2023, the entire contents of which are incorporated herein by reference.

### TECHNICAL FIELD

The present invention relates to automated feature engineering approaches based on constructor type feature generation especially Deep Feature Synthesis (DFS) and the technical field of artificial intelligence such as machine learning to increase ease of use, improve prediction performance, and reduce source (such as processor, memory, storage, etc.) consumption and computation time.

A feature is usually described as an individual measurable or computed property of an observed phenomenon. Combination of mentioned features provides information about the phenomenon. Feature engineering can be defined as creating or selecting features. Creating interpretable, explainable, and effective features determine success of machine learning processes. Although experts are very good at creating features, it is usually the longest part of the predictive modeling processes which is a one of machine learning techniques. It can be estimated that creating or selecting features covers nearly 70 percent of machine learning process time.

With the digitalization process and the widespread use of the internet, the amount and diversity of data has increased significantly in the recent years. This diversification has made data analytics and information extraction processes more complex and time-consuming. Advanced computational resources (e.g., processing devices like CPUs and GPUs, distributed servers), high-capacity data storage systems and parallel processing are required for processing big data. Due to the massive size of such data sets, processing times can be prolonged, taking hours or even days to obtain results. This can limit an organization's ability to make real-time decisions or respond to events efficiently. Extended processing times can lead to project delays in data analysis, potentially resulting in missed opportunities. Therefore, it is important to solve the technical difficulties mentioned above. Since the nature of the data is dynamic; existing features may lose their performance over time because of changes in distributions or events like pandemic. Also, new data sources or products can emerge over time. Furthermore, experts may miss some important data properties due to their personal biases which can lead to reduced machine learning model performance. Therefore, it is important to solve the performance losses mentioned above.

In addition to this, sectors like banking, finance, medicine et cetera are heavily regulated. Regulatory frameworks, and most national regulatory bodies require that the features used in models are “reasonable”, the models themselves are open to human review, and the final decisions are explainable. Furthermore, the business and operation units want the models to be explainable as well to gain insights about the customers and to trust the models. These concerns prohibit businesses from using complex and hard-to-interpret models, so that they rely on domain expertise to develop complex yet informative features that work well with simpler models. The selected features must be interpretable and explainable. Therefore, it is important to solve the explainability problem mentioned above. Specifically, domain-interpretable features are defined as features that make sense when reviewed by a domain expert.

Creating or selecting features are generally a manual process. However, there are ways to create features from data automatically. There are 4 major types of methods; (a) Model-based feature selection, (b) using intermediate layer outputs of pre-trained neural networks, (c) using constructor functions to generate new features from input data or existing features, and (d) creating features using genetic programming and evolutionary computation. Model based approaches aim to create features that work well for a single or multiple models by selecting features that lead to improved model performance. Neural networks transform their inputs to an output through a series of non-linear transformations where each step in the series is usually considered a layer, and their parameters are updated to match desired outputs. The outputs of intermediate layers can be interpreted as learned features. Advantages include not having to design features by hand and ability to control the number of features to avoid feature explosion. The main disadvantages are the question of transferability of the learned features to new problems and the lack of explainability of these features, i.e., the features produced by this method are not intuitive to the human. Constructor type approaches apply hand-defined primitive operations to the data iteratively to produce features independent from a model. Constructor type approaches are not tied to a model and the process can be controlled to create domain-interpretable features by employing suitable primitives and rules. Deep Feature Synthesis (DFS) and AutoFeat methods belong to constructor type of feature synthesis methods. Deep Feature Synthesis (DFS) is designed to work with multiple tables, typically found in business applications. AutoFeat is designed for scientific data. It allows the user/data scientist to specify the units of the input to prevent the creation of physically nonsensical features. However, it is not suitable for business applications.

Genetic programming and evolutionary computation approaches combine existing features together using the ideas from genetic programming and evolutionary computation. These include generating new features from primitives (similar to constructor types) or through genetics, looking at their performance as a fitness function (e.g., via feature importance), and sampling a new population-based on this. Cross-overs and mutations are also sometimes used to create new features. Such generated features have the potential of losing their interpretability.

In the state of art U.S. Pat. No. 11,392,607B2 discloses automated feature engineering during an online scoring phase in a computing environment using one or more computing processors.

In the state of art U.S. patent application document US20200175314A1 discloses predictive data analytics with automatic feature extraction. Embodiments of the present invention provide methods, apparatus, systems, computing devices, computing entities, and/or the like for predictive data analytics with low-order feature extraction.

In the state of art U.S. Pat. No. 11,042,145B2 discloses predictive maintenance, and more specifically, to health indicator learning using reinforcement learning for predictive maintenance.

### SUMMARY

The objective of the present invention is reducing the necessity of technical expertise about a domain to produce new domain-interpretable features for successful machine learning models. The idea is to remove the need for expert feature engineers which may not even exist for new domains.

Another of the objectives of the present invention is reducing the memory and storage requirements and by this way lowering resource consumption while automating domain interpretable and/or domain aware feature creation and/or selection.

Another of the objectives of the present invention is managing feature generation experiments within the sources of the system in case of usage of the mentioned invention by multiple users.

Another of the objectives of the present invention is suggesting statistically significant features and defining quality of features which affect explainability and predictive performance of the model based on features.

Another of the objectives of the present invention is providing a system to deploy the generated and selected features without the need for an expert programmer.

Another of the objectives of the present invention is creating and/or selecting features which are transparent and interpretable by humans automatically while using machine learning methods in a way that satisfies both internal and external concerns. Another of the objectives of the present invention is providing ease of use to users and/or data scientists while creating and/or selecting domain-interpretable features automatically while dealing with machine learning problems.

Another of the objectives of the present invention is to easily generate engineered domain-interpretable features from a database to be used in machine learning problems.

### BRIEF DESCRIPTION OF THE DRAWINGS

The drawings of a present invention embodied to achieve objective of the invention are shown below:

FIGURE is an example of conceptual architecture in accordance with implementations of the present invention.

All parts of the figures are numbered which are referenced as shown below:
1. User
2. Frontend Server
3. Experiment Scheduler
4. Backend Orchestrator
5. Run Scheduler
6. Domain Manager
7. Experiment Manager
8. Data Quality Tester
9. Target Reader
10. Target Tables
11. Raw Reader
12. Raw Tables
13. Sequential Reader
14. Sequential Data
15. Numerical Feature Searcher
16. Time Window Feature Searcher
17. Categorical Feature Searcher
18. Domain Knowledge Tester
19. Candidate Numerical Feature Generator
20. Candidate Time Window Feature Generator
21. Candidate Categorical Feature Generator
22. Sequential Filter module
23. Model Filter
24. Candidates module
25. Run Manager
26. Production Numerical Feature Generator
27. Production Time Window Feature Generator
28. Production Categorical Feature Generator
30. Domain and Experiments DB
31. Source DB
32. Target DB
33. Domain Knowledge Injection module
34. Resource Optimized Candidate Feature Creation
35. Domain Aware Production Feature Creation

### DETAILED DESCRIPTION OF THE EMBODIMENTS

A computer implemented method for synthesizing automatic feature including:
connecting at least a user (1) to at least a user interface in communication with at least a server to generate features,
authorizing the user (1) to access at least one user interface,
selecting the data by user (1) stored in at least a database to generate features,
defining logic elimination rules by the user (1),
exploring candidate features by using a database in communication with the server in accordance with data about the machine learning problem information entered by the user (1),
eliminating the unnecessary features via the user (1) entered logic elimination rules,
filtering the remaining features by another module in communication with the server, wherein the filtering is based on statistical properties and machine learning model performance,
saving filtered features and/or feature generation templates to another database in communication with the server,
generating the filtered features and/or the feature generation templates by at least a command of the user (1) through the user interface,
saving generated the filtered features and/or the feature generation templates to some other database for use in the machine learning problems.

In the computer implemented method according to the present invention at first at least a user (1) is connecting to at least a user interface in communication with at least a server to generate features. After the connection, the user (1) is authorized to access at least one user interface where the user (1) selects the data stored in at least a database to find a solution a machine learning problem. Then, logical elimination rules are defined by the user (1). Then, logical elimination rules are defined by the user. The purpose of these rules is to prevent the interpretation of new variables calculated with one or more input data from being difficult, complex and computationally time-consuming. Therefore, rules such as depth, primitive properties, transformation types, etc. should be defined by the user (1). After that, candidate feature generation templates are explored by using a server in communication with a database which has the data given by the user (1) about the machine learning problem. The candidate feature templates are computation plans to generate features and features are not yet generated from the data. The unnecessary feature candidate templates are eliminated based on the logical elimination rules defined by the user (1). The remaining candidate feature templates are used to generate features from data in batches in accordance with the available computational resources. Then filtering the remaining features is done by another module in communication with the server and said filtering is based on statistical properties and machine learning model performance. Then filtered features and/or feature generation templates are saved to another database by a server. After that the filtered features and/or the feature generation templates are generated by at least a command of the user (1) through the user interface. Finally generated and filtered features and/or the feature generation templates are saved to some other database for use in the machine learning problems. In a preferred embodiment of the method, steps involve multiple distinct servers.

In an embodiment of the present invention the method also includes the step of connecting the user (1) to at least a frontend server (2) and authorizing the user (1) to access at least one user interface through the user screen, wherein the user screen selected from a group consisting of a domains user screen, an experiments user screen and a runs user screen. Domains user screen in the Frontend Server (2), is the interface to the Domain Manager (6) and lets users add/remove new logical rules and/or view existing ones. Experiments user screen in the Frontend Server (2), is the interface to the Experiment Manager (7) and lets users configure and start new experiments, and/or view the properties and results of existing ones. Runs user screen in the Frontend Server (2), is the interface to the Run Manager (25) and lets users configure and start a new run and/or list the status of existing ones.

In an embodiment of the present invention the method also includes the step of the command and/or commands and/or orders received from the user (1) transmitting to a Backend Orchestrator (4) in a RestAPI structure by the Frontend Server (2).

In an embodiment of the present invention the method also includes the step of the command and/or commands and/or orders received from the user (1) transmitting to a subtask schedular by the Backend Orchestrator (4), wherein the subtask schedular selected from a group of consisting an experiment schedular (3) which plans and manages experiment orders and a run schedular (5) plans and manages producing the experiment orders.

In an embodiment of the present invention the method also includes the step of storing and/or saving the feature generation templates in a Domain and Experiments DB (30) by the Domain manager (6) in a way that the user/users (1) can access.

In an embodiment of the present invention the method also includes the step of giving the experiment order by the user (1) through the user experiments user screen which transmits the experiment order to Experiment Schedular (3) through Backend Orchestrator (4), In an embodiment of the present invention the method also includes the step of training a resource usage regression model by using the previous command settings and/or the meta information of source data to estimate resource need of command and/or commands given by the user (1) for the experiment and/or setting up the Experiment Manager (7) if the estimated resource need of the experiment command is provided,

Resource usage regression model can be explained as a machine learning model that makes predictions about new commands' working times, resource needs, etc., based on the information and results of previous commands. According to the outputs of resource usage regression model, resource planning is done more efficiently. For instance, if an experiment that was run using 100 raw data sources took 1 hour and used a maximum of 5 GB of ram, a new experiment with similar settings will create similar resource usage.

In an embodiment of the present invention the method also includes the step of after setting up the Experiment Manager (7) if the estimated resource need of the experiment command is provided, managing data analysis and machine learning steps of the experiment by the Experiment Manager (7),

In an embodiment of the present invention the method also includes the step of reading of at least a Target Table (10) which is a sample and/or samples of the machine learning problem and/or problems of the experiment from a Source DB wherein the user (1) can select via at least a Target Reader (9) to identify the machine learning problem of the user/users (1) to select related features to make the experiment order/command happen.

In an embodiment of the present invention the method also includes the step of reading of at least a Raw Table (12) which is subjective data of the sample and/or samples of the machine learning problem from the Source DB based on the selected machine learning problems via at least a Raw Reader (11) to make the experiment order/command happen.

In an embodiment of the present invention the method also includes the step of reading of at least a Sequential Data (14) which represents time and event series from the Source DB in time order via at least a Sequential Reader (13) to make the experiment order/command happen.

In an embodiment of the present invention, the method also includes utilization of the Target Reader (9), Raw Reader (11) and the Sequential Reader (13) steps in batches to allow large amounts of data to be processed with limited resources.

In an embodiment of the present invention the method controls quality of the data read with the Target Reader (9), the Raw Reader (11) and the Sequential Reader (13), via a Data Quality Tester (8) which performs data type checking, missing data imputation and outlier handling with standard techniques. Data Quality Tester (8) uses clustering methods for outlier handling in addition to standard techniques. The values of the produced features are clustered by methods such as k-Nearest Neighbors and, hierarchical clustering. This clustering is done by collecting similar values together and assigning different values to clusters that are far from each other. Extreme values outside of these clusters are outliers. and replaced with values from the nearest clusters. In this way, outliers in the production phase are handled.

In an embodiment of the present invention the method also includes the step of observing experiment results by the user/users (1), and/or saving experiment results to Domain and Experiment DB (30) to future usage of the experiment results by the Experiment Manager (7), and/or sending the data read by Target Reader (9), the Raw Reader (11) and the Sequential Reader (13) and controlled by the Data Quality Tester (8) to a Domain Knowledge Injection module (33) by the Experiment Manager (7) and/or creating a search space by the Experiment Manager (7).

The search space contains all the feature possibilities (raw data combinations) that can be generated according to the settings in the experiment order. There is one search space for each test order. Search space is often very large, containing many possible attributes, which are meaningful and meaningless. Therefore, it needs to be explored intelligently.

In an embodiment of the present invention the method also includes the step of sending the experiment order/command to a submodule and/or submodules of the Domain Knowledge Injection module (33) which detects subspaces in the search space through a Domain Knowledge Tester (18), wherein the submodule selected from a group of consisting a Numerical Feature Searcher (15), a Time Window Feature Searcher (16) and a Categorical Feature Searcher (17) according to experiment settings, type of raw data and transformation functions by the Domain Knowledge Injection Module (33).

Domain Knowledge Tester (18) is configured to detect predictable and explainable, in other words valuable, subspaces according to the experiment settings, type of raw data and transformation functions. These functions are given by the Domain Knowledge Injection Module (33).

In an embodiment of the present invention the method also includes the step of generating the feature generation templates by using at least one submodule which are the Numerical Feature Searcher (15), the Time Window Feature Searcher (16) and the Categorical Feature Searcher (17) from the meta information of source data.

In an embodiment of the present invention, the method also includes the step of after generating the feature generation templates by the Domain Knowledge Injection Module (33), forwarding the feature generation templates to a Resource Optimized Candidate Feature Creation (34) where the feature generation templates are routed to corresponding generation modules wherein the generation module selected from a group of consisting a Candidate Numerical Feature Generator (19), a Candidate Time Window Feature Generator (20) and/or a Candidate Categorical Feature Generator (21) based on the feature's data type. The related features are generated from data read from the Source DB. The features generation steps are performed in parallel and in batches, and the computational resources and batch size are optimized using the resource usage regression model.

In an embodiment of the present invention, the method also includes utilizing the Target Reader (9), Raw Reader (11) and the Sequential Reader (13) steps in batches to allow large amounts of data to be processed with limited resources.

In an embodiment of the present invention the method also includes the step of after generating candidate features by a group of consisting a Candidate Numerical Feature Generator (19), a Candidate Time Window Feature Generator (20) and/or a Candidate Categorical Feature Generator (21), the selected candidate features are entered into a Sequential Filter module (22) within the Resource Optimized Candidate Feature Creation module (34). The Sequential Filter module (22) filters the candidate features based on statistical properties such as correlation, variance, and Gini scores.

In an embodiment of the present invention the method also includes the step of after passing the statistical filtering methods/steps in the Sequential Filter module (22), the features enter a Model Filter module (23) within the Resource Optimized Candidate Feature Creation module (34). The Model Filter module (23) reduces the number of features by using feature selection algorithms based on machine learning performance either to a user (1) defined number which is given with the experiment command or based on acceptable machine learning performance.

In an embodiment of the present invention the method also runs the Domain Knowledge Injection module (33) and the Resource Optimized Candidate Feature Creation module (34) sequentially and in batches in a loop until the search space is scanned. The resulting features for all the batches are temporarily saved in a hard disk in a Candidates module (24)

In an embodiment of the present invention the method also includes the step of, passing the resulting features of all the batches after the experimental space is scanned through the Sequential Filter module (22) and the Model Filter module (23) for the last time, to select the generated features based on the number features determined in accordance with the experiment order/command given by the user (1) and/or the desired machine learning performance. The generated features and their templates are stored in the Domain and Experiment DB (30). After the elimination, generation and selection steps, the selected features and/or results of the elimination steps and alternative features are presented on the Frontend Server (2) and can be observed by the user (1). Moreover, missing data imputation, outlier handling and statistical elimination methods/steps decided by the Data Quality Tester (8) for every generated and selected feature are also saved in Domain and Experiment DB (30) and available for review on the Frontend Server (2) to be observed by the user (1).

When production/run command and/or commands and/or orders are given by the user (1) through a Frontend Server (2), missing data imputation, outlier handling and statistical elimination methods/steps, and the selected features, all stored in a Domain and Experiment DB (30), are used to generate features from the data to solve a machine learning problem of the user (1).

In an embodiment of the present invention the method also includes the step of after observing the experiment results and/or suggested features and/or outputs of the elimination steps and alternative features on Frontend Server (2) by the user (1), a production order given by the user (1) through the user screen, and/or transmitting the production order to Run Schedular (5) through Backend Orchestrator (4).

In an embodiment of the present invention the method also includes the step of setting up a Run Manager (25) to manage production order using selected experiment results and/or reading the raw data in the Domain and Experiment DB (30) and/or Source DB (31) and/or arranging raw data by the Data Quality Tester (8).

In a preferred embodiment of the present invention, besides the production order statement, the run order statement can also be used.

In an embodiment of the present invention the method also includes the step of after arranging raw data by the Data Quality Tester (8), sending the raw data to a submodule and/or submodules of a Domain Aware Production Feature Creation module (35) which manages a submodule and/or submodules that produce previously discovered and saved features and/or feature templates in the Domain Experiment DB (30) and/or Source DB (31) wherein the submodule selected from a group of consisting a Production Numerical Feature Generator (26), a Production Time Window Feature Generator (27) and/or a Production Categorical Feature Generator (28).

In an embodiment of the present invention the method also includes the step of after the Production Numerical Feature Generator (26), the Production Time Window Feature Generator (27) and the Production Categorical Feature Generator (28) that parallelly produce features related to themselves.

A system for synthesizing automatic feature including at least a processor and at least a memory coupled to at least the processor and configured to provide the processor with instructions configured to perform the steps of the method according to the invention.

A computer program including instructions which, when the program is executed by a computer, cause the computer to carry out the steps of the method according to invention.

A computer-readable storage medium including instructions which, when executed by a computer, cause the computer to carry out the steps of the method according to the invention.

Synthesizing automatic feature expression is used in the sense that includes generating and/or exploring and/or creating and/or filtering and/or producing and/or selecting and/or eliminating meanings.

An example of machine learning problems that the user (1) and/or data scientist tries to find solution can be explained as banking problems such as; credit scoring task (loan, overdraft, credit card), risk modelling (underwriting, limit, delinquency and collection management), marketing (pricing, retention, behavior segmentation, customer profitability, product propensity, campaign management).

Possible features can be explained as counting of 1-31 days past due payments in last 24 months status, credit card installment usage ratio in last 3 months, used card limit over available card limit, total debt-asset ratio, overdraft usage change in last 6 months, customer's all used previous loans provided by other financial institutions that reported to Credit Bureau, customer's monthly balances of previous loans stored in Credit Bureau, number of consumer loans used in last year, annual income-debt difference, customer's top purchase sector, annual product count change, average profit per campaign, campaign acceptance rate in the last 6 months etc.

The system optimizes feature extraction and production processes through the utilization of a distributed network of servers, resulting in enhanced processing speed, reduced computational costs, and improved scalability. Traditional feature engineering methods often encounter limitations in terms of processing speed and scalability, particularly when dealing with large datasets and multiple orders. The disclosed feature engineering software system includes a distributed architecture designed to address the challenges associated with processing multiple orders of large-scale data for feature engineering. The incoming orders are partitioned into smaller subsets, which are then distributed across a network of interconnected servers. This distribution ensures that each server operates on a manageable subset of the orders, thereby optimizing computational efficiency. The distributed architecture enables parallel processing of feature engineering tasks. As each server operates independently on its designated order subset, multiple feature engineering tasks are executed simultaneously, significantly reducing the time required for preprocessing. Thanks to distributed architecture, the system can seamlessly handle multiple orders and large datasets, as the workload is distributed across multiple servers. Parallel processing and the utilization of multiple servers lead to significant reductions in processing time compared to traditional single-server approaches. By optimizing computational resources, the distributed architecture reduces the need for investing in high-end hardware for single-server processing. This translates into cost savings for organizations. The distributed architecture's modular design allows for easy integration of new feature engineering techniques and enhancements as they emerge, ensuring adaptability to evolving data preprocessing needs.

The system employs a microservices architecture, where each component (Experiment Scheduler (3), Run Scheduler (5), Run Managers (25) is encapsulated in a separate container to ensure consistent environments, isolate dependencies, and enable easy deployment. These containers run on a cluster of servers managed by Kubernetes. A Kubernetes cluster manages the deployment, scaling, and orchestration of containers. It provides features like load balancing, automatic scaling, self-healing, and resource management. Raw data is never transferred between micro services, and whichever needs it gets it from the Source DB (31).

The system includes an Experiment Scheduler (3) that efficiently forwards experiment orders to distributed Experiment Managers (7). Experiment Managers (7) conduct feature engineering experiments on separate servers, resulting in optimized data preprocessing and improved scalability for machine learning applications. The Experiment Scheduler (3) is a central component responsible for managing the distribution of feature engineering experiment orders. It receives experiment requests, which include experiment parameters and dataset information. The scheduler intelligently allocates these requests to available Experiment Managers (7) based on load balancing and resource availability. If there are more incoming experiment requests than available resources, the Experiment Scheduler (3) maintains a queue of pending experiments and assigns them to Experiment Managers (7) as they become available.

Multiple Experiment Managers (7) can be deployed across the distributed server architecture. Each manager is equipped with the necessary resources and feature engineering capabilities. Users submit feature engineering experiment orders to the Experiment Scheduler (3). These orders contain information about the dataset, feature engineering techniques to be applied, and any specific parameters. Multiple Experiment Managers (7) are simultaneously processing different experiment orders on separate server nodes. This parallel processing significantly reduces the overall time required for feature engineering experimentation. As Experiment Managers (7) complete their tasks, they communicate the results back to the Experiment Scheduler (3). The Experiment scheduler (3) aggregates these results and provides a consolidated view of the outcomes from various experiments and serve them to Experiments user screen.

Transitioning feature engineering experiments from the experimentation phase to production can be complex, involving data consistency, resource optimization, and scalability challenges. This invention addresses these issues by leveraging a distributed architecture along with a Run Scheduler (5) and Run Managers (25) to enable the smooth productionization of successful feature engineering configurations. Once experiments are completed and the user is satisfied with the results, they may decide to move the chosen feature engineering experiment into a production environment. The Run Scheduler (5) facilitates this transition, It takes orders from users to move specific experiments or configurations to production. Users (1) submit run orders indicating which experiment outcome and configurations to move into production. The Run Scheduler (5) prioritizes incoming run orders based on factors like urgency, data availability, and computational resources. The transition from experimentation to production is streamlined through the Run Scheduler (5) and the Run Managers (25), enabling swift deployment of successful configurations. It determines the suitable Run Managers (25) to handle specific run orders, considering factors like server availability, load balancing, and resource requirements.

Run Managers (25) are responsible for executing and maintaining production-level feature engineering processes. They receive instructions from the Run Scheduler (5) and ensure that the chosen configurations are consistently applied to incoming data in the production environment. Feature engineering configurations applied during experiments are carried over seamlessly to production, ensuring consistent data preprocessing. Run Managers (25) are distributed across the network of servers and are responsible for executing feature engineering configurations in the production environment. Multiple Run Managers (25) can simultaneously process production data on separate server nodes. Parallel execution enhances data preprocessing speed and overall efficiency. The system efficiently scales with data volumes and production demands due to the parallel processing capabilities of Run Managers (25).

What is claimed is:

1. A computer implemented method for synthesizing automatic feature, comprising:
connecting at least a user to at least a user interface in communication with at least a server to generate features,
authorizing the user to access at least one user interface,
selecting data by the user stored in at least a database to generate features,
defining logic elimination rules by the user,
exploring candidate features by using a database in communication with the server in accordance with data about the-machine learning problem information entered by the user,
eliminating unnecessary features via the user entered logic elimination rules,
filtering remaining features by another module in communication with the server, wherein the filtering is based on statistical properties and machine learning model performance,
saving filtered features and/or feature generation templates to another database in communication with the server,
generating the filtered features and/or the feature generation templates by at least a command of the user through the user interface, and
saving generated the filtered features and/or the feature generation templates to some other database for use in machine learning problems.

2. The computer implemented method according to claim 1, further comprising: connecting the user to at least a Frontend server and authorizing the user to access at least one user interface through a user screen, wherein the user screen is selected from a group consisting of a domains user screen, an experiments user screen and a runs user screen.

3. The computer implemented method according to claim 2, wherein the domains user screen in the Frontend Server is an interface to a Domain Manager and lets users add/remove new logical rules and/or view existing ones.

4. The computer implemented method according to claim 2, wherein the experiments user screen in the Frontend Server is an interface to an Experiment Manager and lets users configure and start new experiments, and/or view properties and results of existing ones.

5. The computer implemented method according to claim 2, 4 wherein runs user screen in the Frontend Server is an interface to a Run Manager and lets users configure and start a new run and/or list a status of existing ones.

6. The computer implemented method according to claim 1, further comprising: a command and/or commands and/or orders received from the user transmitting to a Backend Orchestrator in a RestAPI structure by the Frontend Server.

7. The computer implemented method according to claim 1, further comprising: a command and/or commands and/or orders received from the user transmitting to a subtask schedular by a Backend Orchestrator, wherein the subtask schedular is selected from a group of consisting an experiment schedular configured to plan and manage experiment orders and a run schedular configured to plan and manage producing the experiment orders.

8. The computer implemented method according to claim 1, further comprising: storing and/or saving the feature generation templates in a Domain and Experiments DB by a Domain manager in a way that the user/users is allowed to access.

9. The computer implemented method according to claim 1, further comprising: giving an experiment order by the user through experiments user screen, wherein the experiments user screen transmits an experiment order to an Experiment Schedular through a Backend Orchestrator.

10. The computer implemented method according to claim 1, further comprising: training a resource usage regression model by using previous command settings and/or meta information of source data to estimate resource need of command and/or commands given by the user for an experiment and/or setting up an Experiment Manager when an estimated resource need of an experiment command is provided.

11. The computer implemented method according to claim 1, further comprising: after setting up an Experiment Manager when an estimated resource need of an experiment command is provided, managing data analysis and machine learning steps of an experiment by the Experiment Manager.

12. The computer implemented method according to claim 1, further comprising: reading of at least a Target Table which is a sample and/or samples of the machine learning problem and/or problems of an experiment from a Source DB wherein the user selects via at least a Target Reader to identify the machine learning problem of the user/users to select related features to make an experiment order/command happen.

13. The computer implemented method according to claim 1, further comprising reading of at least a Raw Table which is subjective data of a sample and/or samples of the machine learning problem from a Source DB based on the selected machine learning problems via at least a Raw Reader to make an experiment order/command happen.

14. The computer implemented method according to claim 1, further comprising: reading of at least a Sequential Data which represents time and event series from a Source DB in time order via at least a Sequential Reader to make an experiment order/command happen.

15. The computer implemented method according to claim 1, further comprising: utilizing of a Target Reader, a Raw Reader and a Sequential Reader steps in batches to allow large amounts of data to be processed with limited resources and/or controlling a quality of data read with the Target Reader, the Raw Reader and the Sequential Reader via a Data Quality Tester which performs data type checking, missing data imputation and outlier handling with methods such as k-Nearest Neighbors and hierarchical clustering.

16. The computer implemented method according to claim 1, further comprising: observing experiment results by the user/users, and/or saving experiment results to Domain and Experiment DB to future usage of experiment results by an Experiment Manager, and/or sending the data read by a Target Reader, a Raw Reader and a Sequential Reader and controlled by a Data Quality Tester to a Domain Knowledge Injection module by an Experiment Manager and/or creating a search space by the Experiment Manager.

17. The computer implemented method according to claim 1, further comprising: sending an experiment order/command to a submodule and/or submodules of a Domain Knowledge Injection module which detects subspaces in a search space through a Domain Knowledge Tester, wherein the submodule is selected from a group of consisting a Numerical Feature Searcher, a Time Window Feature Searcher and a Categorical Feature Searcher according to experiment settings, type of raw data and transformation functions by the Domain Knowledge Injection Module.

18. The computer implemented method according to claim 17, wherein the Domain Knowledge Tester is configured to detect predictable and explainable, in other words valuable, subspaces according to the experiment settings, type of raw data and transformation functions, where these functions are given by the Domain Knowledge Injection Module.

19. The computer implemented method according to claim 1, further comprising: generating the feature generation templates by using at least one submodule which are a Numerical Feature Searcher a Time Window Feature Searcher and a Categorical Feature Searcher from the meta information of source data.

20. The computer implemented method according to claim 1, further comprising: after generating the feature generation templates by a Domain Knowledge Injection Module, forwarding to the feature generation templates to a Resource Optimized Candidate Feature Creation module where the feature generation templates are routed to corresponding generation modules wherein the generation modules are selected from a group of consisting a Candidate Numerical Feature Generator, a Candidate Time Window Feature Generator and/or a Candidate Categorical Feature Generator based on the feature's data type.

21. The computer implemented method according to claim 19, wherein related features are generated from data read from a Source DB and the features generation steps are performed in parallel and in batches, and computational resources and batch size are optimized using a resource usage regression model.

22. The computer implemented method according to claim 1, further comprising: after generating candidate features by a group of consisting a Candidate Numerical Feature Generator, a Candidate Time Window Feature Generator and/or a Candidate Categorical Feature Generator, allowing the candidate features to enter into a Sequential Filter module within a Resource Optimized Candidate Feature Creation module and then the Sequential Filter module filters the candidate features based on statistical properties such as correlation, variance, and Gini scores.

23. The computer implemented method according to claim 1, further comprising: after passing the statistical elimination methods/steps in a Sequential Filter module, allowing the features to enter a Model Filter module within a Resource Optimized Candidate Feature Creation module.

24. The computer implemented method according to claim 22, wherein the Model Filter module is configured to reduce a number of features by using feature selection algorithms based on machine learning performance, either to a user defined number which is given with an experiment command or based on acceptable machine learning performance.

25. The computer implemented method according to claim 1, further comprising: running a Domain Knowledge Injection module and a Resource Optimized Candidate Feature Creation module sequentially and in batches in a loop until the search space is scanned.

26. The computer implemented method according to claim 1, further comprising: after an experimental space is scanned resulting features temporary saved in a hard disk in a Candidates module.

27. The computer implemented method according to claim 1, further comprising: after an experimental space is scanned, allowing all features from batches to pass through a Sequential Filter module and a Model Filter module for the last time to select the generated features based on number features determined in accordance with an experiment order/command given by the user and/or a desired machine learning performance.

28. The computer implemented method according to claim 1, further comprising: after observing experiment results and/or suggested features and/or outputs of elimination steps and alternative features on a Frontend Server by the user, a production order given by the user through a user screen, and/or transmitting the production order to a Run Schedular through a Backend Orchestrator.

29. The computer implemented method according to claim 1, further comprising: setting up a Run Manager to manage production order using selected experiment results and/or reading raw data in a Domain and Experiment DB and/or a Source DB and/or arranging raw data by a Data Quality Tester.

30. The computer implemented method according to claim 1, further comprising: after arranging raw data by a Data Quality Tester, sending the raw data to a submodule and/or submodules of a Domain Aware Production Feature Creation module which manages a submodule and/or submodules that produce previously discovered and saved features and/or feature templates in a Domain Experiment DB and/or a Source DB wherein the submodule is selected from a group of consisting a Production Numerical Feature Generator, a Production Time Window Feature Generator and/or a Production Categorical Feature Generator.

31. The computer implemented method according to claim 1, further comprising: after a Production Numerical Feature Generator, a Production Time Window Feature Generator and a Production Categorical Feature Generator that parallelly produce features related to themselves.

32. A system for synthesizing automatic feature, comprising: a processor and a memory coupled to the processor and configured to provide the processor with instructions configured to perform steps of the computer implemented method according to claim 1.

33. A computer program, comprising instructions, wherein when the computer program is executed by a computer, the instructions allow the computer to carry out the-steps of the computer implemented method according to claim 1.

34. A computer-readable storage medium, comprising instructions_ wherein when executed by a computer, the instructions allow the computer to carry out steps of the computer implemented method according to claim 1.
